(19) United States
(12) Patent Application Publication
(10) Pub. No.: US 2026/0121463 A1
(43) Pub. Date: Apr. 30, 2026

(54) FOUR-PHASE DIRECT CURRENT MOTOR AND GENERATOR

(71) Applicant: Force Equals Mass Times Acceleration, Inc., Wheat Ridge, CO (US)

(72) Inventors: Thomas Navarro, Wheat Ridge, CO (US); Zachary J. Navarro, West Minister, CO (US); Tiffany J. Navarro, Denver, CO (US)

(21) Appl. No.: 19/429,900

(22) Filed: Dec. 22, 2025

Related U.S. Application Data
(63) Continuation-in-part of application No. 18/301,764, filed on Apr. 17, 2023, now Pat. No. 12,512,726.
(60) Provisional application No. 63/419,373, filed on Oct. 26, 2022.

(51) Int. Cl. H02K 1/16; H02K 1/02; H02K 1/2753; H02K 3/02; H02K 23/12; H02P 6/10; H02P 103/20

(52) U.S. Cl. CPC H02K 1/165; H02K 1/02; H02K 1/2753; H02K 3/02; H02K 23/12; H02P 6/10; H02P 2103/20; H02P 2207/05

(57) ABSTRACT

The disclosure relates to a four-phase motor and generator device with increased efficiency for generating electrical energy. The device features a stator wall with eight stator slots and four pole groups, and an armature rotatable within the stator wall. The eight stator slots are divided into four pole groups of opposing stator slots; the two opposing stator slots include an N (North) stator slot and an S (South) stator slot. N and S stator slots are alternatively activated in response to the rotation of the armature. The activation of the armature pole groups results in armatures rotating the magnetic field within the stator wall, and only four of the eight poles are actively coupled in any given configuration. The disclosure also includes a method of operating the motor for generating electrical energy with increased efficiency and in an environmentally friendly manner compared to conventional motors.

### CROSS-REFERENCE TO RELATED APPLICATIONS

The present application is a continuation-in-part of copending U.S. Utility application Ser. No. 18/301,764, filed Apr. 17, 2023, which in turn claims priority to, and the benefit of, U.S. Provisional Application No. 63/419,373, filed on Oct. 26, 2022, the entirety of each is incorporated by reference.

### FIELD OF THE DISCLOSURE

The present disclosure relates generally to electric generators and more particularly, to a four-phase electric motor and generator device. In one embodiment, the device includes a stator wall with eight stator slots arranged as four opposing pairs (phases A-D). Each pair is bridged by a coil tied to a neutral node, and each slot provides a single-ended direct current (“DC”) output referenced to the neutral (eight outputs total). In addition, a solar panel system may provide four output voltages to a battery system. It should be understood, however, that the disclosed subject matter is not limited to these implementations and may be applied in other devices, applications, and methods of manufacture.

In one embodiment, the device comprises a stator wall of generally circular or cylindrical form with eight stator slots arranged as four opposing pairs, each pair bridged by a coil connected to a neutral node; a permanent-magnet armature having four north and four south poles; and a control scheme that energizes phases A and C during a first DC interval and phases B and D during a second DC interval. The magnetic geometry is selected so that exactly six of the eight stator poles are concurrently coupled at any instantaneous rotor position.

### BACKGROUND

Electric power consumption is essential to modern life, providing energy for lighting, heating, cooling, and refrigeration and for operating appliances, computers, electronics, machinery, and public transportation systems and more. However, increased electric power consumption can adversely impact the environment and ultimately lead to global warming. Large volumes of CO² emissions from worldwide electricity use have contributed significantly to serious environmental challenges such as global warming. Reducing electricity consumption can lower costs, enhance energy security, and decrease pollution from non-renewable energy sources.

Generally, all parts of the electricity system can affect the environment, and the size of these impacts depends on the methods and locations of electricity generation and delivery. Electricity generation produces solid waste, which may include hazardous waste and as well as greenhouse gas emissions and other air pollutants that impact the atmosphere. Conventional single, two-phase, and three-phase generators consume significant energy and operate with limited efficiency. Single-phase generators are affordable but offer the lowest efficiency and are typically used in residential applications. Three-phase generators are more efficient than single phase and two-phase generators, but still fall short and are most commonly used in industrial settings. All types of conventional generators often produce excessive vibrations that can unbalance the rotor and disrupt smooth operation. Accordingly, there is a demand for generators that are both more efficient and environment friendly.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

In one embodiment, the apparatus includes four opposing slot pairs (A-A, B-B, C-C, D-D) formed by eight stator slots on the stator wall, each pair bridged by a coil connected to a neutral. A permanent-magnet armature with four north and four south poles rotates relative to the stator wall. DC phase-interval sequencing energizes A&C, then B&D, to shape slot-level DC delivered at the eight neutral-referenced outputs. The magnetic geometry maintains exactly six slots magnetically coupled at any instant.

The subject matter disclosed and claimed herein, in one embodiment thereof, comprises a method of operating a four-phase direct current motor and generator device. The method comprising the steps of rotating an armature along a stator wall, the stator wall having a circular or cylindrical shape, eight stator slots divided into four pole groups, each pole group has a N (North) stator slot and a S (South) stator slot, wherein four of the stator slots on one side of the stator wall correspond to the other four of the stator slots on an opposing side of the stator wall; alternating activation between N (North) stator slots and S (South) stator slots of the four pole groups in response to the rotation of the armature, wherein eight poles are actively coupled in any given configuration, with exactly eight coupled at any instant; and generating electrical energy with increased efficiency compared to single-phase, two-phase, or three-phase motors.

In yet another embodiment, the activation of the pole groups results in the magnetic fields within the stator wall.

In another aspect of the present disclosure, the stator slots are arranged in a symmetrical pattern around the stator wall.

The stator wall may be formed from stacked magnetic-iron laminations; the coils may be copper windings terminated at a neutral star. The eight slot terminals are routed to the control panel for rectification/commutation and slot-level DC modulation.

In yet another embodiment, a four-phase direct current generator comprising a stator wall and an armature is disclosed. The stator wall having four phases of functional operation and a circular or cylindrical shape with eight stator slots divided into four pole groups, each pole group having a N (North) stator pole and a S (South) stator pole, an eccentric load mass diagram, including eccentric load, located at specific distances from the center axis of rotation of the stator wall, wherein the eccentric load or rotor mass diagram enables the generator to operate efficiently and generate power while compensating for the eccentric load masses.

In yet another embodiment, the four-phase direct current motor and generator device of the present disclosure is easily and efficiently manufactured, marketed, and available to consumers in a cost-effective manner.

In yet still another embodiment, the four-phase direct current motor and generator has eight outputs of current that provide input power for the stator wall from the armature's input power for rotation inside its stator wall with electrical conductor segments from a control panel with the batteries. The output from the four-phase direct current motor and generator has a voltage regulator to stop charging the batteries. Solar Panels will be used in systems that operate in outer space, and charge the batteries, with voltage regulator controls in the control panel can resume charging the batteries when required to provide power from the battery bank for the armatures and stator wall from eight of the outputs of the four-phase direct current motor and generator.

The permanent magnets in the main armature induce a current in the stator wall as the main armature revolves around the center axis of rotation.

Numerous benefits and advantages of this disclosure will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic of the coil/neutral/star and slot-level DC output topology;

FIG. 2 illustrates an embodiment of the present disclosure comprising four armatures configured to rotate inside a stator wall;

FIG. 3 illustrates an embodiment of the present disclosure comprising four armatures configured to rotate inside a stator wall;

FIG. 4 illustrates an embodiment of a four-phase direct current motor and generator device of the present disclosure;

FIG. 5 illustrates is a timing diagram showing A&C and B&D DC phase-interval sequencing with optional lead/lag;

FIG. 6 illustrates an embodiment of the present disclosure wherein eccentric mass loads share the same center axis of rotation;

FIG. 7 illustrates an embodiment of the present disclosure wherein eccentric mass loads share the same center axis of rotation;

FIG. 8 illustrates a timing gear arrangement according to embodiments of the present disclosure; and

FIG. 9 illustrates a horizontal view of the Pod system showing three visible armatures and peripheral Six Pod modules orientations, first is the UP Pod module, second is the DOWN Pod module, third is the RIGHT Pod Module, fourth is the LEFT Pod module, fifth is the FORWARD Pod module (as illustrated in the center of FIG. 9), and sixth is the BACKWARD Pod Moule (as illustrated in the center of FIG. 9 and positioned behind the center of the FORWARD Pod module). Each of the Pod modules are identified as system 10 in FIG. 4.

### DETAILED DESCRIPTION OF THE PRESENT INVENTION

The disclosure is now described with reference to the drawings, wherein reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

There is an ongoing demand for an electric generator that produces environmentally friendly sustainable power. Additionally, there remains a need for an electric generator which is more efficient than existing single, two-phase, and three-phase generators. Further, there is a need for a generator adaptable for both residential and industrial applications. Moreover, a generator with improved rotor balance that minimizes excessive vibrations is desirable. There is also a demand for generators that require less input power for generating electricity. Finally, a four-phase electric generator capable of reducing harmful environmental effects, such as greenhouse gas emissions, is needed.

The subject matter disclosed and claimed herein, in one embodiment, comprises a four-phase direct current motor and generator device. The device is designed to operate more efficiently than single phase, two-phase, and three-phase generators and to be more environmentally friendly. The device further comprising a stator wall having a circular or cylindrical shape, eight stator slots disposed in the stator wall. The eight stator slots are arranged into four pole groups of two opposing stator slots. Each pair of opposing slots are connected via a common coil, the common coil also connects to an output and to a neutral point, one slot of the two opposing stator slots having North polarity (N (North) stator slot) and the other slot having South polarity (S (South) stator slot), four of the stator slots on one side of the stator wall correspond to the other four of the stator slots on an opposing side of the stator wall, an armature, and the device is further configured to alternate activation between N (North) stator slots and S (South) stator slots of the four pole groups in response to rotation of the armature, wherein exactly eight poles are actively coupled in any given configuration.

In this manner, the four-phase direct current motor and generator addresses the forgoing needs by providing efficient and environmentally friendly power generation. The generator may be applied in a wide range of contexts, including residential power, vehicles, and other applications. Further, the generator reduces environmental impact, including greenhouse gas emissions.

Eccentric-mass subsystems may be synchronized for vectoring and vibration management in terrestrial or space platforms. The present disclosure does not rely on non-Newtonian phenomena; any propulsion or translation references are illustrative of potential system-level integrations and are not required for operation of the four-phase generator.

The present disclosure, in one exemplary embodiment, is a method of operating a four-phase direct current motor and generator device. The method comprising the steps of rotating an armature along a stator wall, the stator wall having a circular or cylindrical shape, eight salient poles “stator slots” divided into four pole groups, each pole group has a N (North) stator slot and a S (South) stator slot, wherein four of the stator slots on one side of the stator wall correspond to the other four of the stator slots on an opposing side of the stator wall; alternating activation between N (North) stator slots and S (South) stator slots of the four pole groups in response to the rotation of the armature, wherein exactly eight poles are actively coupled in any given configuration; and generating electrical energy with increased efficiency compared to single-phase, two-phase, or three-phase motors.

For the present disclosure, an eccentric load or rotor mass diagram is considered as a rotor unbalance diagram and is a graphical representation of the eccentricity of the rotor mass in a generator. The diagram is used to determine the amount and location of unbalance in the rotor and to ensure that the generator runs smoothly without causing excessive vibrations. The eccentric load or rotor mass diagram shows the location and magnitude of the unbalance forces acting on the rotor due to the eccentricity of the rotor mass.

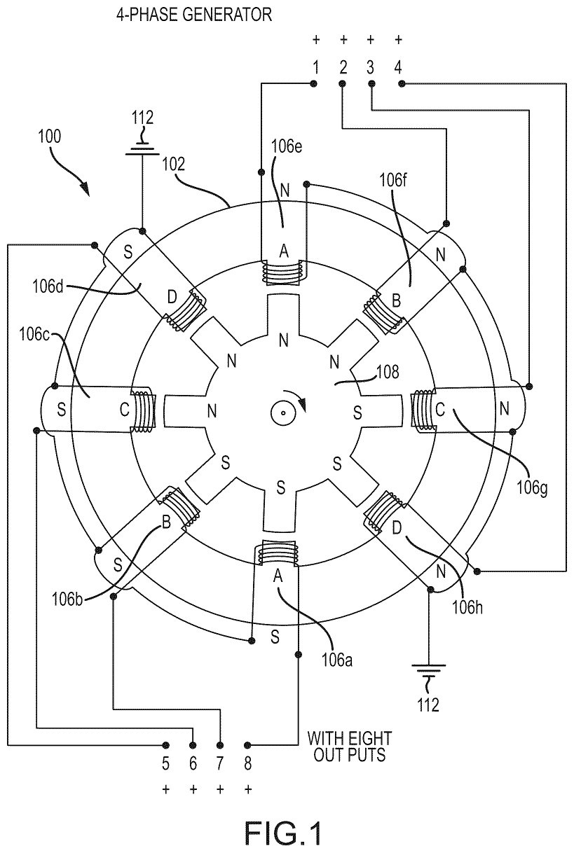

FIG. 1 illustrates an internal view of an embodiment of a four-phase direct current motor and generator with eight electrical load outputs in accordance with the disclosed architecture. The four-phase direct current motor and generator 100 of the present disclosure is configured as an electrical machine. The four-phase direct current motor and generator 100 is more efficient than conventional generators and consumes less energy. More specifically, the machine 100 includes a stator wall 102 and an armature 108. The stator wall 102 features four phases of functional operation, which is an advantage over existing single-phase, two-phase, and three-phase motors. As illustrated, the stator wall 102 has eight stator slots 106a, 106b, 106c, 106d, 106e, 106f, 106g, 106h denoted as “A-A” 106a, 106e; “B-B” 106b, 106f; “C-C” 106c, 106g; and “D-D” 106d, 106h. Four stator slots, 106a, 106b, 106c, and 106d, on one side of the stator wall 102, correspond to the other four stator slots, 106e, 106f, 106g, and 106h, for a symmetrical polarity on the stator wall 102. In some embodiments the symmetrical polarity may be on a side of the stator wall 102. In other embodiments, the North polarity stator slots (106e, 106f, 106g, 106h) are positioned on one side of the stator wall 102, and the South polarity stator slots (106a, 106b, 106c, 106d) are positioned on the other side of the stator wall 102. The stator slots are arranged in a symmetrical pattern around stator wall 102, and stator wall 102 has a circular or cylindrical shape.

FIG. 1 further illustrates the four pole groups configured on stator walls 102, and each pole group includes a pair of corresponding stator slots on opposing sides of the stator walls 102. As a result, the one pole group is defined by two “A-A” stator slots, and similarly, other pole groups are defined by corresponding “B-B” stator slots together, “C-C” stator slots together, and “D-D” stator slots together. During use, the rotation of the armature 108 causes the four pole groups to alternate in activation between N (North) stator slots and S (South) stator slots. The armatures' 108 rotating magnetic fields within the stator wall 102 generates an electrical current in the stator wall 102. This configuration is beneficial because exactly eight stator slots are magnetically coupled at any instant, which reduces ripple on the eight neutral-referenced DC outputs.

In another embodiment, the stator wall 102 is comprised of magnetic material, such as magnetic lamination material, and the activation of the pole groups results in the magnetic field of the stator wall 102. The armature 108 functions as a rotor and includes a plurality of permanent magnetic poles 108 positioned at the center of the stator wall 102 and comprising an arrangement of four North and four South polarities positioned opposite one another. As further explained below, the batteries can provide power for the DC motor that rotates the permanent magnet armature 108. The permanent magnet 108 may be a neodymium magnet or any other suitable type of permanent magnet. The control panel can modulate the amount of current from the batteries along with a DC motor that rotates the four-phase direct current motor generator in direct proportions or separate direct current feeds from the control panel modulated manually or controlled by an automation control program for the DC motor that rotates the armature 108 with permanent magnet arrangement with four North poles and four South poles.

FIG. 1 further illustrates an embodiment of the present disclosure wherein a four-phase generator 100 forming four pole groups alternating between N (North) stator slots and S (South) stator slots, thereby generating more electrical energy than existing single-phase, two-phase, and three-phase motors and thus increasing energy efficiency. Further, the four-phase generator 100 reduces harmful effects on the environment, like greenhouse gas emissions, more efficiently than three-phase, two-phase, and single-phase electric power. In an embodiment, N (North) stator slots 1, 2, 3, 4, 5, 6, 7, and 8 are used for providing eight-phase outputs. As illustrated, the slots 106e, 106f, 106g, and 106h may also have their ground (neutral), and 106a, 106b, 106c, and 106d may also have their ground (neutral), 112.

For each opposing pair, a coil bridges the pair and connects at one end to the neutral star node 112 and at the other ends to two slot terminals that are rectified/commutated to provide single-ended DC per slot (eight outputs referenced to the neutral). As used herein, “slot-level DC” means a single-ended DC output available at each individual slot terminal, referenced to the common neutral node, obtained by commutating/rectifying coil outputs associated with the opposing pair. FIG. 1 schematically illustrates the neutral star node 112, coil connections for A-A, B-B, C-C, D-D, the eight slot terminals 1-8, and the rectification/commutation elements within the control panel that produce single-ended DC per slot.

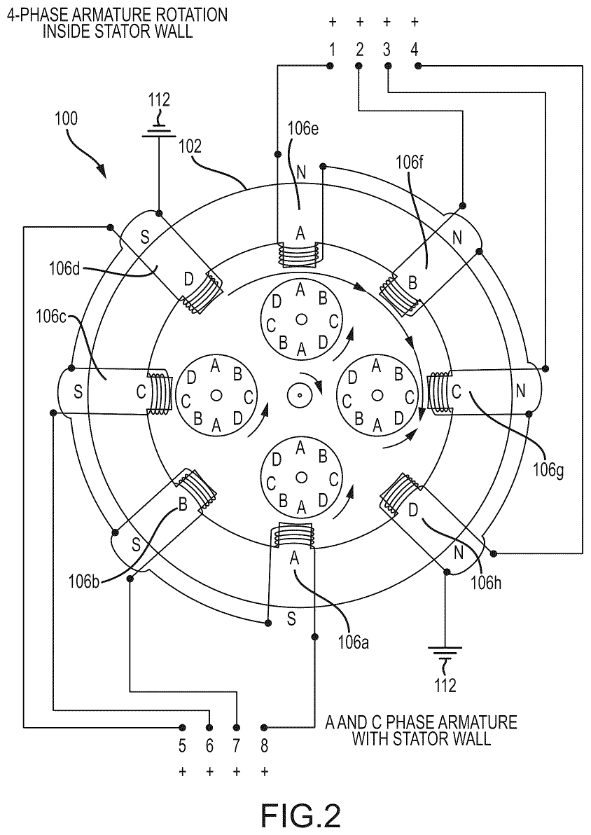

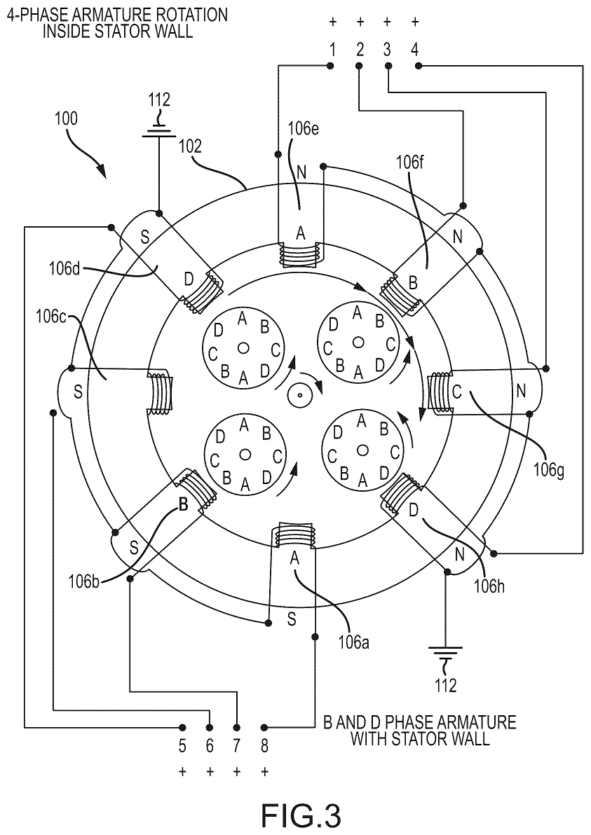

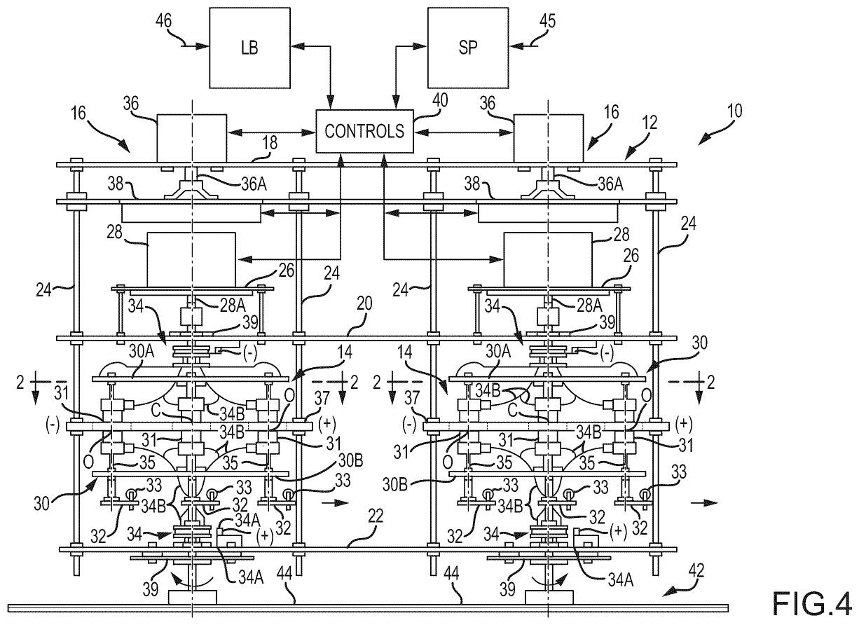

FIG. 2 and FIG. 3 illustrate four armature rotations inside the stator wall, which receives its power from the eight electrical load outputs as illustrated in FIG. 1. FIG. 4 illustrates eight armatures, four on the left right sides of the drawings, wherein four of the armatures rotate clockwise and the other four armatures rotate counterclockwise.

As illustrated in FIGS. 2 and 3, phase A may be formed by opposing stator slots 106a and 106e, phase B may be formed by opposing stator slots 106b and 106f, phase C may be formed by opposing stator slots 106c and 106g, and phase D may be formed by opposing stator slots 106d and 106h. The voltage of each phase is formed when the permanent magnet 108 aligns with the opposing stator slots. As illustrated in FIG. 1, the voltage of each phase may be formed when the permanent magnet 108 aligns with the eight stator wall slots.

In some embodiments, as illustrated in FIG. 1, the South pole and North pole of the permanent magnet 108 align with the opposing stator slots 106e, 106a, respectively, and as a result, the peak voltage of phase A may be achieved. As the armature permanent magnet 108 rotates and aligns with other sets of opposing stator slots, the voltage and current are generated. The permanent magnet 108 may be, but is not limited to, a permanent or rare earth magnet within the armature 108.

FIG. 4 illustrates an embodiment of the present disclosure comprising a controlled translational force generating system 10. The system 10 may comprise a control panel 40, a plurality of direct current motors 36, and generators 38. Embodiments may further comprise a battery bank 46 “LB” and a solar panel distribution arrangement 45 “SP”. A plurality of conduits may be configured to extend from the control panel 40 to motors 28 and 36 and to generators 38, and may also be configured to join communication rings 34 and 34A (brushes) as illustrated.

In certain embodiments, as illustrated in FIG. 4, the system 10 may operate in either the Earth's gravitational field or the Higgs Field of outer space. A set of initial translational forces may be generated by subsystems 14 through interaction with the eccentric mass load environment produced by the second set 33 and 32. Together, these subsystems 14 may produce a steerable, straight-line resultant translational force that causes the system 10 to move in a constant direction. This vectoring refers to controlled distribution of dynamic forces via synchronized eccentric masses; it is optional and independent of the generator's electrical operation.

As further shown in FIG. 4, direct current motors 36 may comprise shafts 36A that are mechanically coupled to the permanent magnetic armature 108 of the four-phase generator 100, as illustrated in FIG. 1. The permanent magnetic armature 108 may be configured to rotate within the stator wall 102, inducing current when the direct current motors 36 operate. As shown in FIG. 1, stator wall 102 may be configured to produce output currents 1, 2, 3, 4, 5, 6, and 8 for output electric loads. This occurs as a result of the axial air gap of the permanent magnetic armature 108, which induces current flow into the windings of stator wall slots 106a, 106b, 106c, 106d, 106e, 106f, 106g, and 106h.

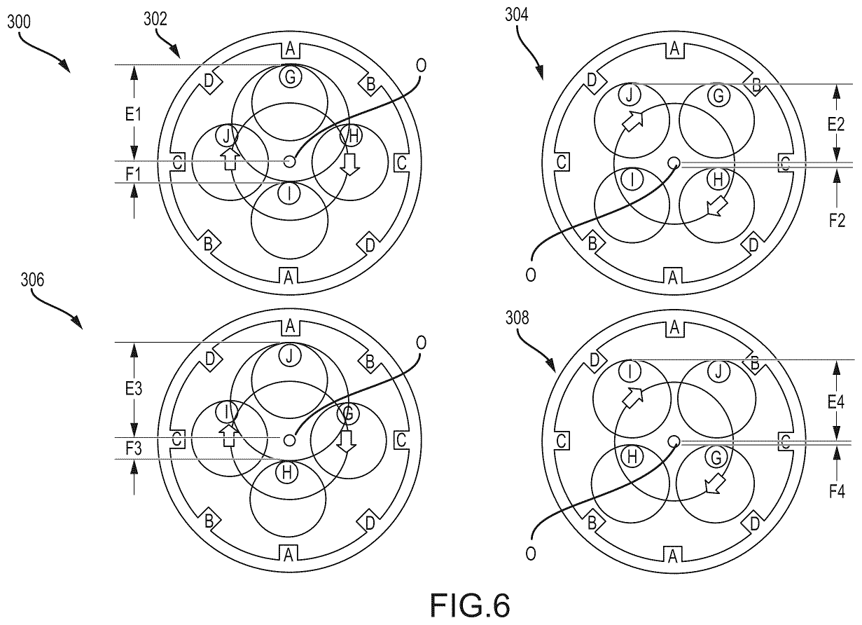

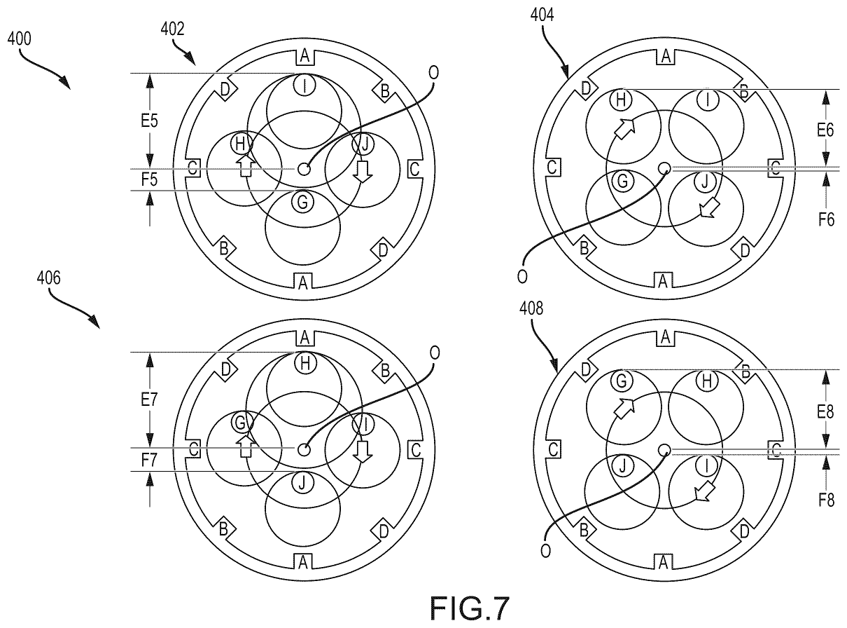

In some embodiments, by variably adjusting the rotations per minute of the parallel eccentric load mass 33, system 10 may move in a constant direction, with the eccentric mass loads 33 providing an arrow indicating the direction of movement. This vectoring refers to controlled distribution of dynamic forces via synchronized eccentric masses; it is optional and independent of the generator's electrical operation. Details of the eccentric mass loads are provided in FIG. 6 and in the operational sequence of FIG. 7.

In the some embodiments, the main frame 12 may comprise upper horizontal platforms 18, middle horizontal platforms 20, and lower horizontal platforms 22, supported in vertically spaced relation by vertical legs 24. By way of illustration only, rather than a limitation, horizontal platforms 18, 20, and 22 are depicted as rectangular in shape. Vertical legs 24, eight in number (with only four shown along one of the opposite sides of frame 12), may be attached to and support the horizontal platforms 18, 20, and 22 at spaced locations along their perimeters.

In yet other embodiments, the controlled translational force generating system 10 may comprise a first and second set of subsystems 14 mounted on a main frame 12 and may be configured to generate translational forces through the second set 33 and 32.

As illustrated in FIG. 4, each direct current motor 36 may comprise a center shaft 36A, as also shown in FIG. 1. The center axis shaft of the permanent magnetic armature 108 may be mechanically coupled to shaft 36A. Each generator 38 may represent the four-phase direct current motor and generator 100 with eight outputs as illustrated in FIG. 1.

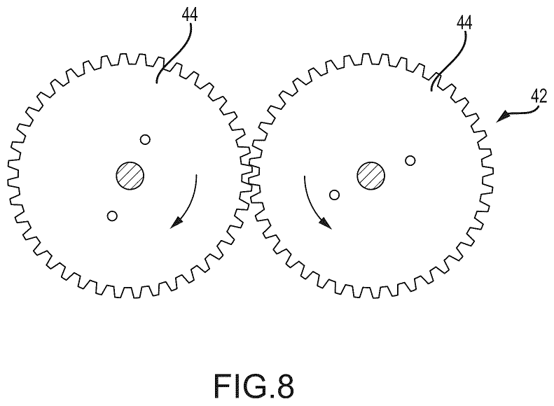

As further illustrated in FIG. 4, system 10 includes synchronizing means 42 in the form of a pair of large timing gears 44 (as further illustrated in FIG. 8). These gears are mounted in the same horizontal plane, have equal diameters, and are in peripheral engagement with one another. They are connected to the lower ends of orbital frame center axis shafts 30.

In some embodiments, the control panel 40 may be electrically joined to the direct current motors 28 and 36, the generators 38, and the communication rings 34, 34B, and 34A.

FIG. 4 further illustrates embodiments wherein the armature coils may be soldered to the top and bottom of a copper communications ring 34. The brushes 34A may be mechanically attached to a shaft with dielectric hardware. From the brushes, a conductor 34B segment may be connected to a control panel 40 configure to regulate current. The control panel may selectively load or unload current to or from the coils of each of the four armatures, in communication with the batteries, via automated or manual controls or voltage and current for each armature.

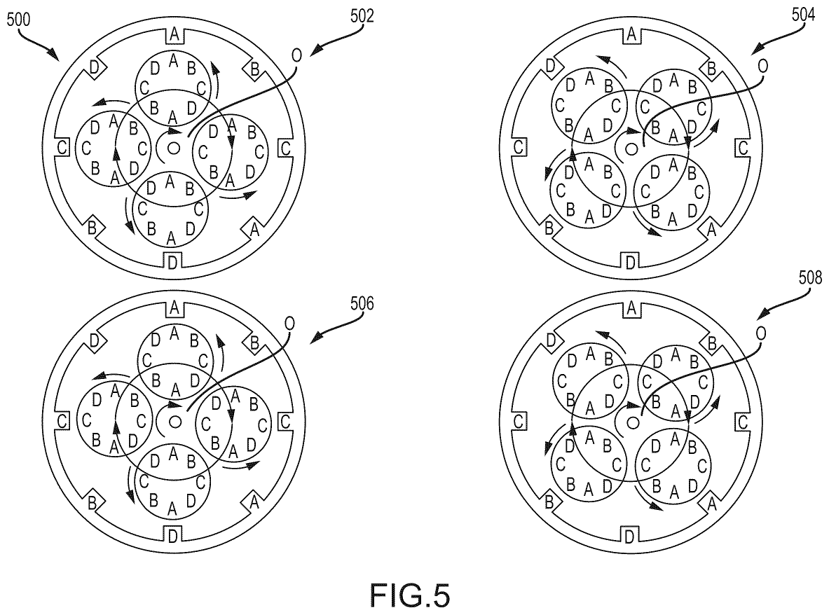

FIG. 5 depicts DC phase-interval sequencing: during a first interval, phases A and C are energized; during a second interval, phases B and D are energized. The control panel imposes a selectable electrical lead/lag between the intervals to minimize ripple measured at the eight slot-level outputs. FIG. 5 illustrates four armatures' electrical/magnetic relationships with, for example, the stator wall. As shown, the rotation of the center axis “O” is clockwise. However, the rotation can be arranged in a counterclockwise orientation as well. Diagram 502 illustrates a power source providing power to the armatures and stator wall, resulting in the armatures revolving about the center axis of rotation “O” and facing a first direction. The stator and armature of diagram 502 displays the four-phase stator wall magnetic relationship with the four-phase armatures, with “A” and “C” phase power first. Diagram 502 represents a display of the “A” and “C” phase power stator wall and energized armatures. Diagram 504 illustrates a power source providing power to the armatures and stator wall, resulting in the armatures revolving about the center axis of rotation “O” and facing a second direction. The stator and armature of diagram 504 display the four-phase stator wall magnetic relationship with the four-phase armatures with “B” and “D” phase power second. Thus, Diagram 504 represents a display of the “B” and “D” phase power stator wall and energized armatures. Diagram 506 illustrates a power source providing power to the armatures and stator wall, resulting in the armatures revolving about the center axis of rotation “O” and facing the first direction. The stator and armature of Diagram 506 displays the four-phase stator wall magnetic relationship with the four-phase armatures with “C” and “A” phase power third. Thus, Diagram 506 represents a display of “C” and “A” phase power stator walls and energized armatures. Diagram 508 illustrates a power source providing power to the armatures and stator wall, resulting in the armatures revolving about the center axis of rotation “O” and facing the second direction. The stator and armature of diagram 508 displays the four-phase stator wall magnetic relationship with the four-phase armatures with “D” and “B” phase power fourth. Thus, Diagram 508 represents a display of the “D” and “B” phase power stator wall and energized armatures. The full revolution cycle repeats from 508 to 502, next to 504, and then to 506, resulting in armatures revolving about the center axis of rotation and facing the same direction while revolving about the center axis of rotation. The revolutions per minute of the center axis of rotation shall be increased or decreased to maximize or minimize the effects of the eccentric mass load upon the center axis of rotation for translational force generation to move the system in a direction that is constant. This vectoring refers to controlled distribution of dynamic forces via synchronized eccentric masses; it is optional and independent of the generator's electrical operation.

FIG. 5 may show representative interval durations, duty cycles, and lead/lag Δθ between A/C and B/D. In one example, interval durations are equal, with Δθ tuned via feedback to maintain output-ripple below a predetermined threshold. Ripple feedback may be obtained from slot-level voltage/current sensors and processed to adjust Δθ and duty cycle in real time

FIG. 5 further illustrates an embodiment wherein a first system rotates in a counterclockwise motion about its center axis and a second system rotates in a clockwise motion about its center axis of rotation. These systems, 502, 504, 506, and 508, are optionally arranged in succession so that the eccentric load mass may be configure to peak at the “A” phase to control the effects of the eccentric mass loads upon the center axis of rotation O, resulting in the systems as illustrated in FIG. 6 moving in the direction of greatest distance of eccentric mass loads “J,” “G,” “H,” and “I,” defined as “E1,” “E2,” “E3,” “E4,” “E5,” “E6,” “E7,” and “E8,” distances from the center axis of rotation “O”.

Some embodiments disclose the eccentric mass on each of the four-phase armatures, moving the systems in the direction of the eccentric mass loads “G,” “H,” “I,” and “J” out furthest from the center axis of rotation. The top and bottom of each of the four armatures will have a single brush top and a single brush bottom, and conductor segments that go to a control panel where amps are regulated to the armature's windings.

FIG. 6 illustrates the eccentric load mass diagram for the functioning of the four-phase direct current motor and generator device of the present disclosure by the disclosed architecture. The eccentric load mass diagram 300 illustrates a graphical representation of the eccentric mass in the four-phase armatures rotation inside the stator wall 102. In FIG. 6 and FIG. 7, the diagram illustrates the relationship between the stator wall 102 and the eccentric load masses.

FIG. 6, further illustrates an embodiment of the present disclosure wherein four circles each correspond with one phase of the four-phase direct current motor and generator. The first circle 302 indicates the starting point of the rotation of the center axis of the rotor, which is clockwise in this case. However, the four-phase direct current motor and generator 100 can also be wired for counterclockwise rotation per the application if required. In the first circle 302, the “A” phase Axial air gap from the stator wall “G” is minimal, and distance “E1” extends from the center axis of rotation.

In other embodiments, the eccentric load mass is indicated by the letter “G,” which is located at a distance “E1” from the center axis of rotation “O”. The eccentric load mass is indicated by the letter I and is located at a distance “F1” from the center axis of rotation “O”. Additionally, the first circle 302 shows the location of the eccentric load mass, indicated by the letter J,” and the location of the eccentric load mass, indicated by the letter “H”.

In yet another embodiment, a second circle 304 illustrates the eccentric load mass G and J, wherein both are located at a distance “E2” from the center axis of rotation “O”, while the eccentric load mass “I” and “H” are located at a distance “F2” from the center axis of rotation “O”.

In another embodiment, a third circle 306 illustrates the eccentric load mass J which is positioned at a predefined distance “E3” from the center axis of rotation “O”, while the eccentric load mass H is positioned at a distance F3 from the center axis of rotation “O”.

In another embodiment, a fourth circle 308 illustrates the eccentric load mass I and J, wherein both are positioned at a distance E4 from the center axis of rotation “O”, while the eccentric load mass H and G are positioned at a distance F4 from the center axis of rotation “O”.

FIG. 6 and FIG. 7 further illustrate embodiments wherein the eccentric mass loads “G,” “H,” “I” and “J” share the center axis of rotation “O” as illustrated in FIG. 5, thereby allowing the stator wall and armatures to maintain the eccentric mass loads at a distance “E” and “F” from the center axis of rotation “O” of the present disclosure.

FIG. 6 and FIG. 7 further detail operations of the eccentric mass loads of subsystems mounted inside the main frame 12 located within box 38 as illustrated in FIG. 4. The eccentric mass loads configured to have the same mass weight.

FIGS. 4, 6, and 7, further illustrate an embodiment of the present disclosure wherein each of the parallel eccentric mass load subsystems 14 of the controlled translational force-generating systems 10 which generate the respective initial translational forces may be configured to include an auxiliary frame 26, a rotary drive motor 28, an orbital frame 30, a plurality of first orbital members 32, and a communications ring dielectric to shaft 34, 34A, wherein the carbon electric brush may be insulated from electrical contact and mounted on a deck 22. The rotary drive motor 28 may be mounted to the auxiliary frame 26 and may have a rotary output shaft 28A extending downwardly through the auxiliary frame 26. The orbital frame 30 may be mounted to the legs 24 of the main frame 12 and joined to the rotary output drive shaft 28A of the rotary drive motor 28 for, but not limited to, undergoing revolutions about a central axis “C” upon operation of the rotary drive motor 28. The orbital frame 30 may be composed of an upper deck 30A and horizontal deck 30B, and a plurality of support shafts 35 configured to extend between and journaled at opposite ends by bearings 39 to the upper and lower decks 30A, 30B. The first orbital members' 32 eccentric mass load devices may be mounted on the orbital frame 30 and configured to undergo revolutions with the orbital frame 30 about the central axis “C”.

In some embodiments, the eccentric mass loads first orbital members 32 may also be mounted to the orbital frame 30 and configured to undergo rotation about an orbital axis “0” relative to the orbital frame 30. Each of the first orbital members 32 may be further configured to support eccentric mass load weights 33, which may be used to define an offset center of mass of the respective first orbital members 32. Thus, the first orbital members 32 may have their centers of mass predisposed eccentric mass load in relation to a preset angular position relative to the respective orbital axes “0”.

In some embodiments, electrical coupling mechanisms 34, which may include electrical brushes 34A and electrical conductors 34B, may be electrically coupled to a plurality of second orbital members 31 for providing predetermined levels of electrical power, producing rotation of the second orbital members 31 in a first direction about their orbital axes “0” at the same frequency as the first orbital members 32, undergoing revolutions with the orbital frame 30 in a second opposite direction about the central axis “C”. In such a manner, the center of eccentric mass loads of orbital members 32 may be maintained at the respective preset angular position relative to orbital axis “0” and thereby the first orbital members 32 may be asymmetrically accelerated relative to the central axis “C” to impart a respective one of an initial translational force to the main frame 12 of the system 10.

In yet other embodiments, the electromagnetic implementation of the eccentric load mass subsystems 14 and the first orbital members 32 may share the same shaft as the orbital armatures mounted to support the shafts 35, and the rotation-producing coupling may stand for an annular stator 37 stationarily mounted to legs 24 of the main frame 12 and configured to surround the orbital armatures. The orbital armatures may preferably be four in number as illustrated in FIG. 2 and FIG. 3, and in an electromagnetic relationship with the stator wall 37. Direct Current (DC) variable voltage power may be supplied to the stator wall 37 and the orbital armatures.

In some embodiments this process may be carried out by the implementation of superconductors, wherein superconductivity can be used to create superconducting magnetic fields in the electromagnetic implementation of subsystem 14. Concerning the pair of parallel eccentric mass load subsystems, 14 of the controlled translational force generating system 10, the respective directions of rotation and revolutions of the orbital frames 30 and orbital members 32 of the one subsystem 14 may be counter to the respective direction of rotation and revolutions of the orbital frame 30 and orbital members of 32 of the other subsystems 14. For instance, the orbital frame 30 of the right eccentric load mass subsystem 14 as illustrated in FIG. 4 may rotate counterclockwise about its respective central axis “C”, whereas the orbital frame 30 of the left eccentric load mass subsystem 14 as further illustrated may rotate clockwise about its respective central axis “C”. Additionally, the orbital members of the right orbital frame 30 may rotate clockwise about their respective orbital axes “0”, whereas the orbital members of the left orbital frame 30 may rotate counterclockwise about their respective orbital axes “0”. The counter-rotational relationship of the respective components of the one subsystem 14 relative to the corresponding components of the other subsystem 14 and the parallel relationship of the central rotational axes “C” of the subsystem 14 may be configured to cause a mostly straight-line orientation of the combined translational force which results from the initial translational force generated by the combined operation of the subsystems 14.

For the present disclosure, Eccentric loads mass “G,” “H,” “I,” and “J” as illustrated in FIG. 6 and FIG. 7 may display the locations of the eccentric mass loads as they rotate about the center axis of rotation distances from the center axis “E” and “F”.

FIG. 7 further illustrates an embodiment depicting an eccentric load mass diagram 400 for a four-phase direct current motor and generator device. The diagram 400 displays the relationship between the four-phase stator wall and eccentric load masses. However, the eccentric load masses are uniquely positioned in the diagram 400, starting with a first circle 402. The first circle 402 illustrating eccentric load mass “I”, which may be positioned at a distance “E5” from the center axis of rotation “O”, while eccentric load mass “G” may be positioned at a distance “F5” from the center axis of rotation “O”. The eccentric load mass locations of “H” and “J” are also displayed in the first circle 402.

FIG. 7 further illustrates an embodiment wherein a second circle 404 depicts the eccentric load masses “H” and “I” positioned at a predefined distance “E6” from the center axis of rotation “O”, while eccentric load masses “G” and “J” are positioned at a predefined distance “F6” from the center axis of rotation “O”. A third circle 406 illustrates the eccentric load mass “H” positioned at a predefined distance “E7” from the center axis of rotation “O”, while eccentric load mass “J” is positioned at a predefined distance “F7” from the center axis of rotation “O”.

In some embodiments, a fourth circle 408 illustrates eccentric load masses “G” and “H” positioned at a predefined distance “E8” from the center axis of rotation “O”, while eccentric load masses “J” and “I” are positioned at a predefined distance “F8” from the center axis of rotation “O”.

In embodiments of the present disclosure, the four circles 402, 404, 406 and 408 illustrate a complete cycle. The cycle then repeats between the eccentric load mass diagram 300 as depicted in FIG. 6 and the eccentric load mass diagram 400 as depicted in FIG. 7. The alternating pattern of the eccentric load masses in the two diagrams 300 and 400 helps the eccentric load mass by maximizing the force of the four-phase direct current motor and generator 100 in a constant direction.

The four-phase direct current motor generator 100 may be further configured to display the location of the eccentric mass loads as they revolve about their center axis of rotation. These eccentric mass loads “G,” “H,” “I,” and “J,” may comprise identical load masses, and as they revolve around the center axis of rotation other electric devices in the control panel may regulate the current to the four armatures inside the stator wall and regulate the current to the stator wall.

In some embodiments, one eccentric mass load system revolves clockwise, and the other eccentric mass load system revolves counterclockwise about their respective center axis of rotation. Some systems may be configured to display four armatures in a first system and four armatures in a second eccentric mass load system, totaling eight armatures within a pair of stator walls. As a result, both eccentric mass load systems may move in unison, being closest to and furthest from the center axis of rotation simultaneously, thereby generating movement of the system in a constant direction relative to the Earth's gravitational field or in the Higgs Field in outer space. This vectoring refers to controlled distribution of dynamic forces via synchronized eccentric masses; it is optional and independent of the generator's electrical operation.

In contrast, embodiments of the present disclosure comprise an eccentric mass load system having four eccentric mass loads revolving clockwise about a center axis of rotation and another four eccentric mass loads revolving counterclockwise about its respective center axis of rotation. The result is a system that moves in a constant direction in the gravitational field of the Earth or the Higgs Field that exists in outer space. Embodiments of the present disclosure may include two eccentric mass load systems, for example, four eccentric mass loads revolving clockwise and four eccentric mass loads revolving counterclockwise within their respective stator walls. The result is the movement of the eccentric mass loads or eccentric rotor masses in a constant direction as the eccentric mass loads “G”, “H”, “I” and “J” as these eccentric mass loads occupy “E1,” “E2,” “E3,” “E4,” “E5,” “E6,” “E7” and “E8” furthest distance from the center axis of rotation, as they revolve about the center axis of rotation “0”. Such movement is illustrated in FIG. 6 and FIG. 7. This vectoring refers to controlled distribution of dynamic forces via synchronized eccentric masses; it is optional and independent of the generator's electrical operation.

FIG. 8 illustrates an embodiment of the present disclosure, wherein timing gears 44 may be configured to rotate in opposite directions, corresponding to the counter-rotation of subsystems 14, thereby maintaining synchronization between the subsystems 14. Although FIG. 8 depicts mechanical synchronization via timing gears 44, in alternative embodiments synchronization may be achieved electromagnetically.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “four-phase direct current motor and generator device”, “four-phase generator”, “generator”, and “motor and generator device” are interchangeable and refer to the four-phase direct current motor and generator device 100 of the present disclosure.

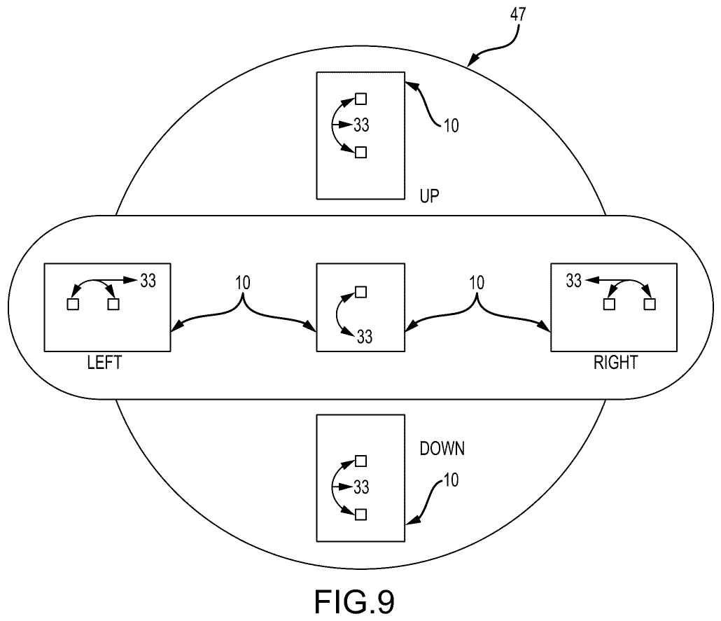

FIG. 9 presents a horizontal (plan) view of a Pod system 10 (as illustrated in FIG. 4). In this view only three armatures are visible because the fourth, “opposite” armature is collinear with and directly behind the center armature along the viewing axis.

In the same horizontal view, only three of the Pod systems 10 (as illustrated in FIG. 4) are visible for the same reason: the opposite Pod system 10 lies directly behind the central most Pod system 10 along the line of sight. For orientation, the assemblies may be labeled UP, DOWN, LEFT, and RIGHT around the periphery; the fifth assembly, opposite the central most Pod system 10, is behind the central most Pod system 10, wherein the central most Pod system bay be labeled as FORWARD, and the Pod system 10 disposed opposite from it along a horizontal plane may be labeled as the BACKWARD Pod system 10.

The reduced count of visible components results from the horizontal projection used here (and in FIG. 4), Pod system 10: elements that are axially aligned with the viewer (center and opposite) are visually coincident, so only three distinct armatures/Pod systems 10 can be seen in plan.

Selective energization enables vectoring, as illustrated in FIG. 9: driving the UP Pod system 10 produces upward translation; DOWN produces downward translation; LEFT produces leftward translation; and RIGHT produces rightward translation, wherein the central most Pod system may be labeled as the FORWARD Pod system, and the Pod system 10 disposed opposite from it along a horizontal plane may be labeled as the BACKWARD Pod system 10.

Energizing each of the central most Pod systems 10 separately may produce translation toward a predefined reference direction; energizing its opposite selected Pod system 10 may produce translation in an opposite direction from that predefined reference direction. Motions can be commanded manually or via automation through the CONTROLS panel 40 (not shown in FIG. 9).

In FIG. 4, the drawing of the two systems 14 only three of the armatures can be viewed horizontally, as the center armature has one directly behind it, however in FIG. 2 and FIG. 3 each of the four armatures are clearly displayed.

Notwithstanding the forgoing, the four-phase direct current motor and generator device 100 of the present disclosure can be of any suitable size and configuration as is known in the art without affecting the overall concept of the disclosure, provided that it accomplishes the above-stated objectives. One of ordinary skill in the art will appreciate that the four-phase direct current motor and generator device 100, as shown in the figures is for illustrative purposes only and that many other sizes and shapes of the four-phase direct current motor and generator device 100 are well within the scope of the present disclosure. Although the dimensions of the four-phase direct current motor and generator device 100 are important design parameters for user convenience, the four-phase direct current motor and generator device 100 may be of any size that ensures optimal performance during use and/or that suits the user's needs and/or preferences.

Any description of translation or vectoring is provided to illustrate load-allocation and synchronization; the generator's novelty resides in its four-phase DC topology with eight slot-level outputs and controlled coupling, not in propulsion claims.

Various modifications and additions can be made to the exemplary embodiments discussed without departing from the scope of the present disclosure. While the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A four-phase direct-current apparatus, comprising:
a stator wall having eight stator slots arranged as four opposing pairs that define phases A, B, C, and D;
a coil associated with each opposing pair and connected to a neutral node;
a permanent-magnet armature having four north poles and four south poles in alternating order and rotatable relative to the stator wall; and
an electrical configuration in which each stator slot is terminated as a single-ended direct-current (DC) output referenced to the neutral node, thereby providing eight slot-level DC outputs,
wherein a magnetic geometry of the stator wall and the permanent-magnet armature is selected such that exactly eight stator slots are concurrently magnetically coupled to the permanent-magnet armature at any instantaneous angular position of the permanent-magnet armature, and
wherein a DC phase-interval sequence energizes phases A and C during a first interval and phases B and D during a second interval to shape slot-level current delivered at the eight outputs.

2. The apparatus of claim 1, wherein the stator wall comprises stacked magnetic-iron laminations and each coil comprises copper windings, and wherein the neutral node is connected to the coils bridging the opposing pairs.

3. The apparatus of claim 1, wherein each stator slot has a dedicated terminal forming the eight slot-level DC outputs referenced to the neutral node.

4. The apparatus of claim 1, wherein exactly eight stator slots are magnetically coupled at any instant, thereby reducing ripple on the eight neutral-referenced DC outputs.

5. The apparatus of claim 1, further comprising a controller configured to implement the DC phase-interval sequence such that phases A and C lead phases B and D by a fixed electrical angle, thereby flattening current ripple delivered at the eight slot-level outputs.

6. The apparatus of claim 1, further comprising a synchronization interface configured to coordinate a relative angular position of a plurality of permanent-magnet armatures via mechanical timing gears, thereby maintaining synchronization between counter-rotating subsystems while the apparatus delivers slot-level DC at the eight outputs.

7. The apparatus of claim 2, wherein a control panel includes a voltage regulator configured to stop charging of a battery bank and to resume charging when required, while maintaining delivery of neutral-referenced DC from the eight slot-level outputs to external loads.

8. The apparatus of claim 2, further comprising a solar panel array providing supplemental DC to the control panel, and logic configured to blend solar-derived DC with generator-derived DC for battery maintenance and load support without interrupting availability of the eight slot-level outputs.

9. The apparatus of claim 2, wherein a communication-ring interface comprises a pair of conductive rings per armature and a single brush at a top location and a single brush at a bottom location, the brushes being dielectrically mounted and connected to the control panel to enable independent slot-level DC routing and modulation.

10. A direct-current motor-generator system, comprising:
a four-phase apparatus having a stator wall with eight stator slots grouped as four opposing pairs, coils bridging the opposing pairs and tied to a common neutral, and a permanent-magnet armature with four north and four south poles;
a control panel including switching elements and current regulators;
a communication-ring interface with brushes coupled between the coils and the control panel to enable independent slot-level DC modulation;
a battery bank and a voltage regulator configured to stop and resume battery charging under control of the control panel; and
a solar panel array providing supplemental DC to the control panel;
wherein the system is configured to deliver eight neutral-referenced DC outputs at the slot level concurrently with battery charging, and to allocate slot-level DC among external loads, eccentric-mass drives, and charging in accordance with control-panel commands.

11. The system of claim 10, wherein the control panel is configured to implement a DC phase-interval sequence in which phases A and C are energized during a first interval and phases B and D are energized during a second interval, and to apply a selectable phase lead or lag between the intervals to reduce ripple on the eight neutral-referenced DC outputs while coordinating power allocation to an eccentric-mass subsystem.

12. The system of claim 10, further comprising a synchronization subsystem selected from mechanical timing gears and electromagnetic phase control, the synchronization subsystem being operative to maintain a predefined relative angular relationship among multiple armatures for vectoring and eccentric load mass management while the system delivers the eight slot-level DC outputs.

13. The system of claim 10, wherein the communication-ring interface comprises a pair of conductive rings per armature and a single brush at a top location and a single brush at a bottom location, the brushes being dielectrically mounted and connected via conductor segments to the control panel to enable independent slot-level DC routing and modulation.

14. The system of claim 10, wherein the voltage regulator is configured to suspend charging of the battery bank when a charging condition is satisfied and to resume charging when a control-panel condition indicates that additional charge is required to supply power from the battery bank to the armatures and the stator wall.

15. A method of generating direct current in a four-phase direct-current apparatus, comprising:
rotating a permanent-magnet armature having four north and four south poles within a stator wall having eight stator slots arranged as four opposing pairs each bridged by a coil connected to a neutral node;
sequencing direct-current energization such that four phases, designated A, B, C and D, are energized through a first interval and a second interval, wherein phases A and C are energized during the first interval and phases B and D are energized during the second interval, thereby producing eight single-ended direct current outputs referenced to the neutral node;
maintaining instantaneous magnetic coupling such that exactly eight stator slots are magnetically coupled to the armature at any given angular position; and
distributing slot-level direct current among an eccentric-mass subsystem, external loads, and a battery-charging path governed by charge-cutoff and charge-resumption conditions defined by a voltage regulator.

16. The method of claim 15, wherein sequencing the direct-current energization further comprises applying a selectable electrical lead or lag between the A/C interval and the B/D interval based on feedback of ripple measured at the eight outputs, thereby maintaining a ripple magnitude below a predetermined threshold while the eight single-ended direct current outputs remain referenced to the neutral node.

17. The method of claim 15, further comprising sensing slot-level voltage and current at each of the eight outputs and, responsive to the sensed values, prioritizing distribution of slot-level direct current among the eccentric-mass subsystem, the external loads, and the battery-charging path according to a policy implemented by the control panel.

18. The method of claim 15, wherein distributing slot-level direct current further comprises blending solar-derived direct current with apparatus-derived direct current under control of the control panel, the blending being configured to maintain battery charging during simultaneous supply to external loads while preserving the eight single-ended outputs referenced to the neutral node.

19. The method of claim 15, wherein synchronizing multiple armatures comprises mechanically coupling the armatures by timing gears to maintain a fixed electrical angle relationship between the armatures during the first and second intervals, thereby maintaining synchronization between counter-rotating subsystems.

20. The method of claim 15, further comprising supplying at least a portion of the slot-level direct current from the eight outputs to a direct-current motor mechanically coupled to the permanent-magnet armature so that the apparatus operates as a motor-generator.
